(19) United States
(12) Patent Application Publication
(10) Pub. No.: US 2016/0267438 A1
(43) Pub. Date: Sep. 15, 2016

(54) Scheduling an Appointment to Complete a Transaction

(71) Applicant: Bank of America Corporation, Charlotte, NC (US)

(72) Inventors: Craig Sobol, Waxhaw, NC (US); Christian Mande, Charlotte, NC (US); Jon R. Wolf, Charlotte, NC (US); Jeremy V. Rizzo, Huntersville, NC (US)

(21) Appl. No.: 14/641,985

(22) Filed: Mar. 9, 2015

(51) Int. Cl. G06Q 10/10; G06Q 40/02

(52) U.S. Cl. CPC G06Q 10/1095; G06Q 40/02

(57) ABSTRACT

A user device may transmit login information for an account of the user to a computing system or platforms. After the user is logged in, the user may select a transaction type for a transaction that the user would like to setup using the user's device and send the transaction type selection to the computing system. The computing system can process the transaction information and determine available locations and times at the available locations to complete the transaction based on at least one of the transaction type, services available at a location, a profile of the user, and a preferred location of the user. The available locations and the times at the available locations may be transmitted to the user device. Based on the available locations and times, the user can select a location and time at the location for the appointment to complete the transaction. The computing system can receive the appointment request and schedule the transaction for completion at the selected time and location.

### BACKGROUND

Online banking and mobile banking have provided customers of a bank with the ability to bank at their convenience and perform a variety of transactions without having to visit branch locations of a bank. Some transactions still require a visit to a branch location where the customer may have to spend some time waiting for a bank associate's assistance and/or for a bank associate to process the transaction.

### SUMMARY

The following presents a simplified summary in order to provide a basic understanding of some aspects of the disclosure. This summary is not an extensive overview of the disclosure. It is neither intended to identify key or critical elements of the disclosure nor to delineate the scope of the disclosure. The following summary merely presents some concepts of the disclosure in a simplified form as a prelude to the description below.

In accordance with one or more aspects, a user device may transmit login information for an account of the user to a computing system or platforms. After the user is logged in, the user may select a transaction type for a transaction that the user would like to setup using the user's device and send the transaction type selection to the computing system. The computing system can process the transaction information and determine available locations and times at the available locations to complete the transaction based on at least one of the transaction type, services available at a location, a profile of the user, and a preferred location of the user. The available locations and the times at the available locations may be transmitted to the user device. Based on the available locations and times, the user can select a location and time at the location for the appointment to complete the transaction. The computing system can receive the appointment request and schedule the transaction for completion at the selected time and location.

In some aspects, the determination of available location and times may be based on whether the transaction type corresponds to a specialist transaction type, a specialist product, and/or a user type. In response to determining that the transaction type corresponds to the specialist transaction type, the availability of associates who assist with the specialist transaction type may be transmitted to the user device. In response to determining that the user profile of the user includes a specialist product, the availability of associates who service the specialist product may be transmitted to the user device.

In some aspects, the requested transaction may be pre-processed. An associate at the location selected in the appointment may prepare the transaction before the appointment time. Once the user or a designated party arrives at the location selected in the appointment, the user can meet with an associate and pick up the prepared transaction.

Other details and features will be described in the sections that follow.

### BRIEF DESCRIPTION OF THE DRAWINGS

The present disclosure is pointed out with particularity in the appended claims. Features of the disclosure will become more apparent upon a review of this disclosure in its entirety, including the drawing figures provided herewith.

Some features herein are illustrated by way of example, and not by way of limitation, in the figures of the accompanying drawings, in which like reference numerals refer to similar elements, and wherein:

FIG. 1 depicts an illustrative operating environment in which various aspects of the present disclosure may be implemented in accordance with one or more aspects described herein.

FIG. 2 depicts an illustrative block diagram of workstations and servers that may be used to implement the processes and functions of certain aspects of the present disclosure in accordance with one or more aspects described herein.

FIG. 3 depicts an illustrative computing environment for completing a pre-staged transaction at a selected time and location in accordance with one or more aspects described herein.

FIGS. 4A-4C depict an illustrative event sequence for completing a pre-staged transaction at a selected time and location in accordance with one or more aspects described herein; and

FIG. 5 depicts an illustrative method for completing a pre-staged transaction at a selected time and location in accordance with one or more aspects described herein.

FIG. 6 shows an illustrative method for determining available locations and times to complete the transaction in accordance with one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

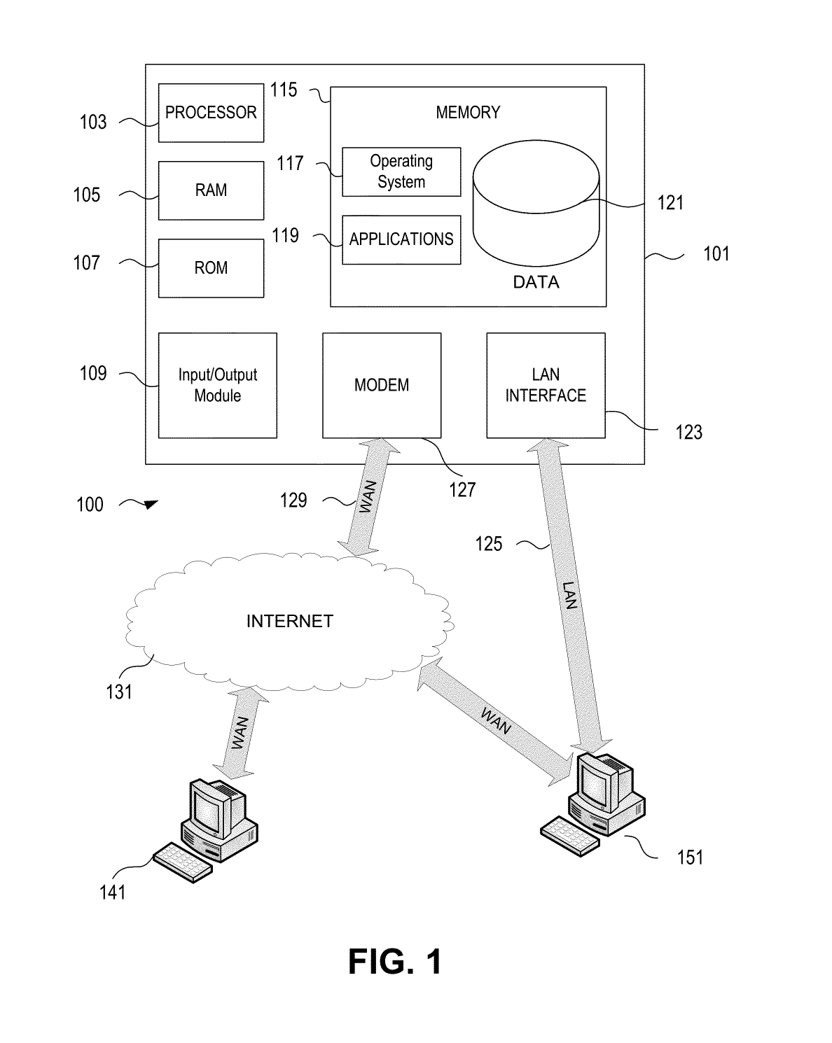

FIG. 1 depicts an illustrative operating environment in which various aspects of the present disclosure may be implemented in accordance with one or more example embodiments. Referring to FIG. 1, computing system environment 100 may be used according to one or more illustrative embodiments. Computing system environment 100 is only one example of a suitable computing environment and is not intended to suggest any limitation as to the scope of use or functionality contained in the disclosure. Computing system environment 100 should not be interpreted as having any dependency or requirement relating to any one or combination of components shown in illustrative computing system environment 100.

Computing system environment 100 may include computing device 101 having processor 103 for controlling overall operation of computing device 101 and its associated components, including random-access memory (RAM) 105, read-only memory (ROM) 107, communications module 109, and memory 115. Computing device 101 may include a variety of computer readable media. Computer readable media may be any available media that may be accessed by computing device 101, may be non-transitory, and may include volatile and nonvolatile, removable and non-removable media implemented in any method or technology for storage of information such as computer-readable instructions, object code, data structures, program modules, or other data. Examples of computer readable media may include random access memory (RAM), read only memory (ROM), electronically erasable programmable read only memory (EEPROM), flash memory or other memory technology, compact disk read-only memory (CD-ROM), digital versatile disks (DVD) or other optical disk storage, magnetic cassettes, magnetic tape, magnetic disk storage or other magnetic storage devices, or any other medium that can be used to store the desired information and that can be accessed by computing device 101.

Although not required, various aspects described herein may be embodied as a method, a data processing system, or as a computer-readable medium storing computer-executable instructions. For example, a computer-readable medium storing instructions to cause a processor to perform steps of a method in accordance with aspects of the disclosed embodiments is contemplated. For example, aspects of the method steps disclosed herein may be executed on a processor on computing device 101. Such a processor may execute computer-executable instructions stored on a computer-readable medium.

Software may be stored within memory 115 and/or storage to provide instructions to processor 103 for enabling computing device 101 to perform various functions. For example, memory 115 may store software used by computing device 101, such as operating system 117, application programs 119, and associated database 121. Also, some or all of the computer executable instructions for computing device 101 may be embodied in hardware or firmware. Although not shown, RAM 105 may include one or more applications representing the application data stored in RAM 105 while computing device 101 is on and corresponding software applications (e.g., software tasks), are running on computing device 101.

Communications module 109 may include a microphone, keypad, touch screen, and/or stylus through which a user of computing device 101 may provide input, and may also include one or more of a speaker for providing audio output and a video display device for providing textual, audiovisual and/or graphical output. Computing system environment 100 may also include optical scanners (not shown). Exemplary usages include scanning and converting paper documents, e.g., correspondence, receipts, and the like, to digital files.

Computing device 101 may operate in a networked environment supporting connections to one or more remote computing devices, such as computing devices 141, 151, and 161. Computing devices 141, 151, and 161 may be personal computing devices or servers that include any or all of the elements described above relative to computing device 101. Computing device 161 may be a mobile device (e.g., smart phone) communicating over wireless carrier channel 171.

The network connections depicted in FIG. 1 may include local area network (LAN) 125 and wide area network (WAN) 129, as well as other networks. When used in a LAN networking environment, computing device 101 may be connected to LAN 125 through a network interface or adapter in communications module 109. When used in a WAN networking environment, computing device 101 may include a modem in communications module 109 or other means for establishing communications over WAN 129, such as Internet 131 or other type of computer network. The network connections shown are illustrative and other means of establishing a communications link between the computing devices may be used. Various well-known protocols such as transmission control protocol/Internet protocol (TCP/IP), Ethernet, file transfer protocol (FTP), hypertext transfer protocol (HTTP) and the like may be used, and the system can be operated in a client-server configuration to permit a user to retrieve web pages from a web-based server. Any of various conventional web browsers can be used to display and manipulate data on web pages.

The disclosure is operational with numerous other general purpose or special purpose computing system environments or configurations. Examples of well-known computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like.

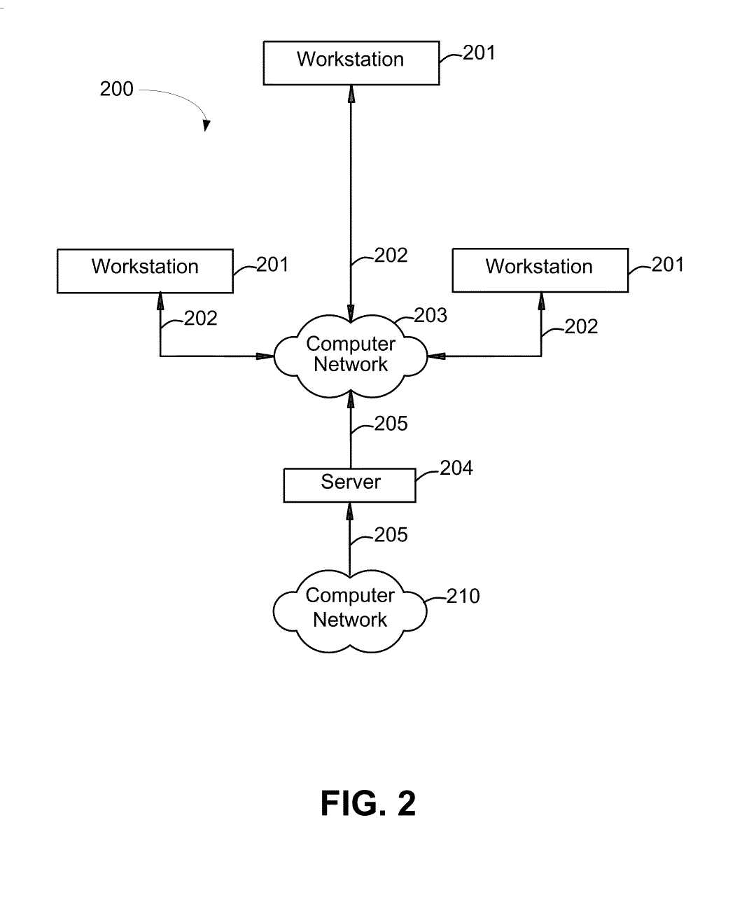

FIG. 2 depicts an illustrative block diagram of workstations and servers that may be used to implement the processes and functions of certain aspects of the present disclosure in accordance with one or more example embodiments. Referring to FIG. 2, illustrative system 200 may be used for implementing example embodiments according to the present disclosure. As illustrated, system 200 may include one or more workstation computers 201. Workstation 201 may be, for example, a desktop computer, a smartphone, a wireless device, a tablet computer, a laptop computer, and the like. Workstations 201 may be local or remote, and may be connected by one of communications links 202 to computer network 203 that is linked via communications link 205 to server 204. In system 200, server 204 may be any suitable server, processor, computer, or data processing device, or combination of the same. Server 204 may be used to process the instructions received from, and the transactions entered into by, one or more participants.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and server 204, such as network links, dial-up links, wireless links, hard-wired links, as well as network types developed in the future, and the like.

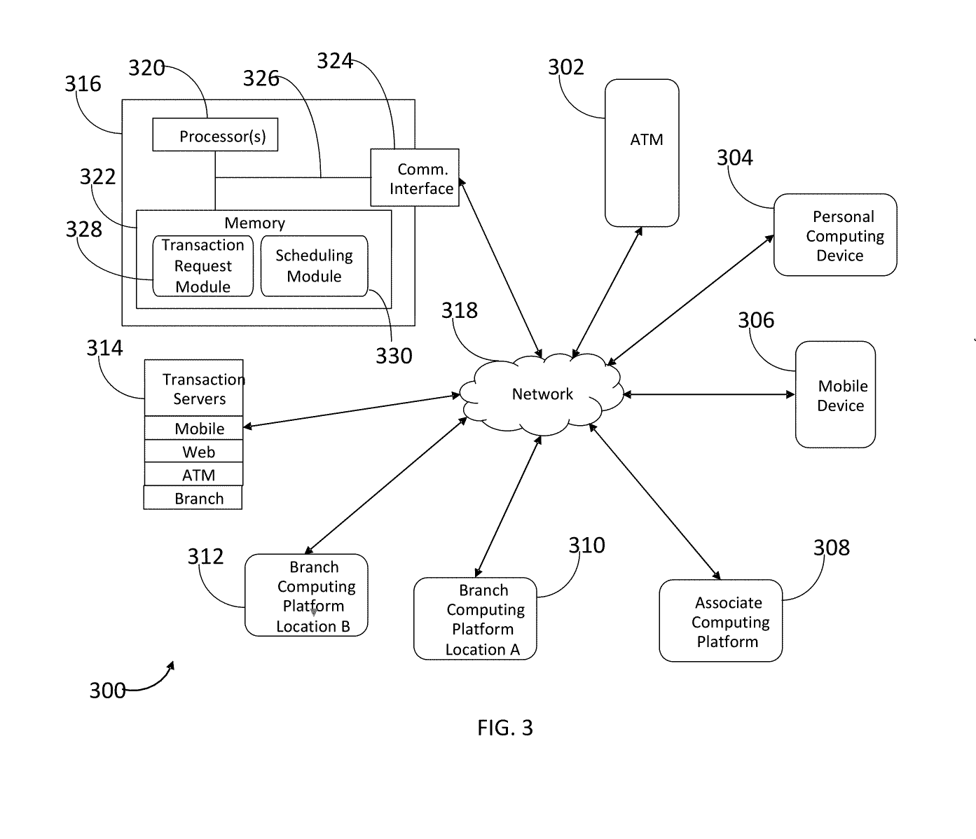

FIG. 3 depicts an illustrative computing environment for scheduling an appointment to complete a transaction according to one or more aspects described herein. Referring to FIG. 3, computing environment 300 may include one or more computing platforms. For example, computing environment 300 may include ATM 302, personal computing device 304, mobile device 306, associate computing platform 308, branch computing platform 310, branch computing platforms 310, 312, transaction servers 314, and computing platform 316. ATM 302 may be a computing platform configured to perform one or more financial transactions (e.g., withdrawals, deposits, or the like). ATM 302 may be configured to support an audio/visual conference session between an individual utilizing ATM 302 and an associate of a financial institution associated with ATM 302. Personal computing device 304 may be any type of computing device capable of providing an individual with an interface for performing a financial transaction with a financial institution (e.g., a desktop computer, laptop computer, or the like). For example, personal computing device 304 may be a desktop computer executing a web browser application that presents a website associated with the financial institution for performing one or more financial transactions with the financial institution. Mobile device 306 may be any type of portable computing device capable of providing an individual with an interface for performing a financial transaction with a financial institution (e.g., a mobile phone, smartphone, personal digital assistant (PDA), personal media device, tablet computer, or the like). For example, mobile device 306 may be a smartphone executing an application associated with a financial institution for performing one or more financial transactions with the financial institution.

Associate computing platform 308, branch computing platform 310, and branch computing platform 312 may be any type of computing platform configured to perform and/or assist an individual in performing a financial transaction with a financial institution. For example, associate computing platform 308 may be a desktop computer executing an application for performing a financial transaction with a financial institution and/or for assisting an individual in performing a financial transaction with a financial institution. Associate computing platform 308 may be configured to support an audio/visual conference session between an associate of a financial institution utilizing associate computing platform 308 and an individual utilizing ATM 302, personal computing device 304, and/or mobile device 306. For example, associate computing platform 308 may be configured to support an audio/visual conference session between an associate of a financial institution utilizing associate computing platform 308 and an individual utilizing ATM 302. Branch computing platforms 310 and 312 may include one or more computing devices configured to perform and/or assist an individual in performing a financial transaction with a financial institution. For example branch computing platforms 310 and 312 may include one or more computing devices (e.g., desktop computers, laptop computers, terminals) utilized by associates of a financial institution working at a particular branch of a financial institution to perform and/or assist an individual in performing a financial transaction with a financial institution (e.g., a deposit, funds transfer, withdrawal, or the like). Branch computing platform 310 may include one or more computing devices associated with a branch located at a particular geographic location (e.g., location A), and branch computing platform 312 may include one or more computing devices associated with a branch located at a different geographic location (e.g., location B).

Transaction servers 314 may include one or more computing devices (e.g., mainframes, servers, blades, or the like) configured to manage and maintain records associated with a financial institution and/or its customers. Transaction servers 314 may also include one or more computing devices configured to interface the financial institution or one or more computing devices associated with the financial institution (e.g., one or more of transaction servers 314, branch computing platform 310, branch computing platform 312, and/or associate computing platform 308) with customers or individuals desiring to perform one or more financial transactions associated with the financial institution, and/or one or more computing platforms utilized by a customer or individual desiring to perform one or more financial transactions associated with the financial institution (e.g., ATM 302, personal computing device 304, and/or mobile device 306). Network 318 may interconnect one or more of ATM 302, personal computing device 304, mobile device 306, associate computing platform 308, branch computing platform 310, branch computing platform 312, transaction servers 314, and/or computing platform 316. Network 318 may include one or more sub-networks (e.g., LANs, WANs, or the like).

Computing platform 316 may include one or more processor(s) 320, memory 322, communication interface 324, and data bus 326. Data bus 326 may interconnect processor(s) 320, memory 322, and/or communication interface 324. Communication interface 324 may be a network interface configured to support communication between computing platform 316 and network 318, or one or more sub-networks thereof. Memory 322 may include one or more program modules comprising instructions that when executed by processor(s) 320 cause computing platform 316 to perform one or more functions described herein. For example, memory 322 may include transaction request module 328 and scheduling module 330. Transaction request module 328 may comprise instructions that when executed by processor(s) 320 cause computing platform 316 to receive a request for a financial or monetary transaction from a user device (e.g., ATM 302, personal computing device 304, and/or mobile device 306). The financial or monetary transaction type may include a change order, money order, savings bond redemption, cashier's check, certified check, official check, banker's check, after hours depository, and/or temporary or permanent debit/credit card requests. Scheduling module 330 may comprise instructions that when executed by processor(s) 320 cause computing platform 316 to receive an appointment scheduling request from a user device (e.g., ATM 302, personal computing device 304, and/or mobile device 306) and process the appointment scheduling request. Processing of the appointment scheduling request may include determining available locations and available times for completing a transaction requested in a transaction request according to aspects described herein. One or more transaction servers 314 may include one or more memories including the scheduling module 330 which can comprise instructions that when executed by one or more processors of the one or more transaction servers cause the one or more transaction servers 314 to receive and process an appointment scheduling request according to aspects described herein.

The instructions may also cause computing platform 316 to create a record for the transaction request, and store the record for the transaction request in a database comprising a plurality of records for transaction requests. The instructions may further cause computing platform 316 to receive search criteria specifying one or more aspects of the record for the transaction request from a computing device associated with the financial institution (e.g., branch computing platform 310 or 312), and utilize the search criteria specifying one or more aspects of the record for the transaction request to identify, from amongst the plurality of records for transaction requests, the record for the transaction request. The instructions may further cause computing platform 316 to communicate information stored in the record for the transaction request to the computing device associated with the financial institution.

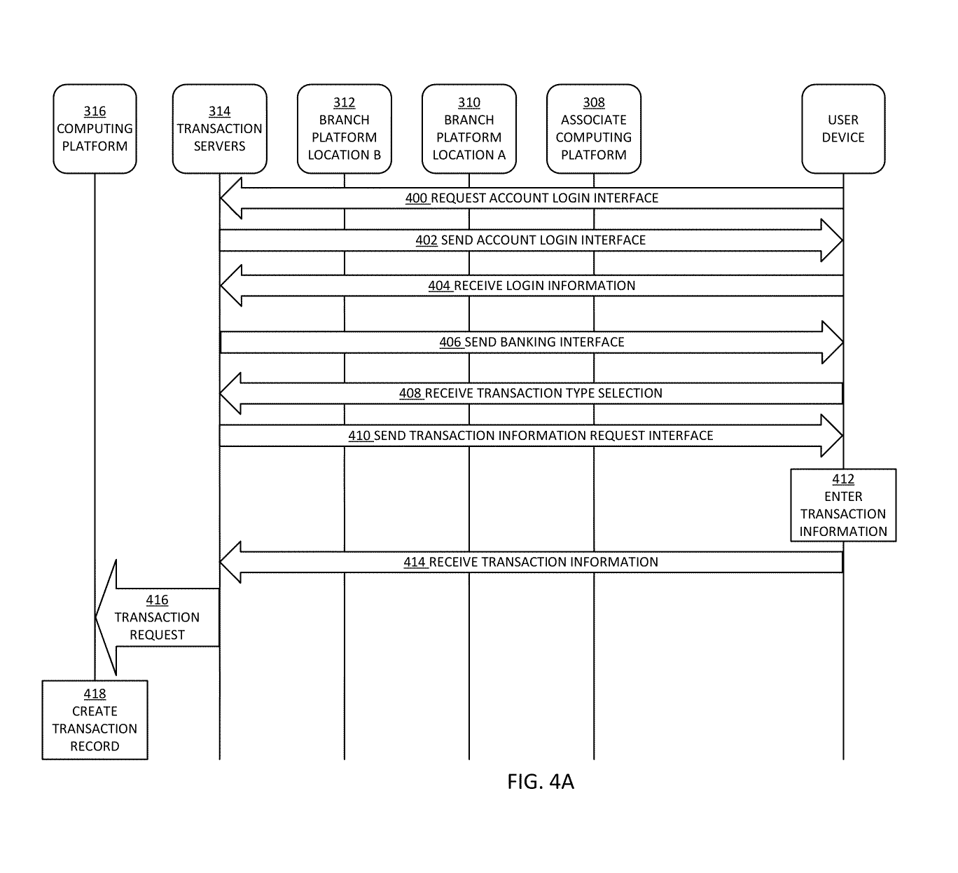

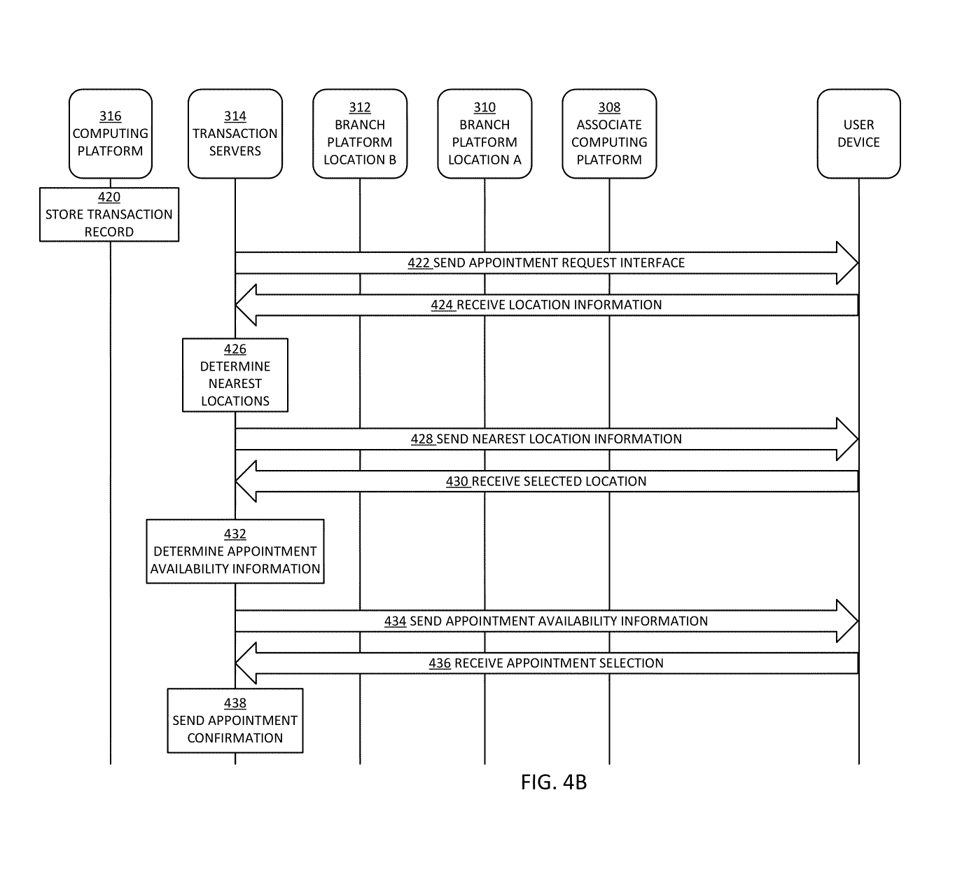

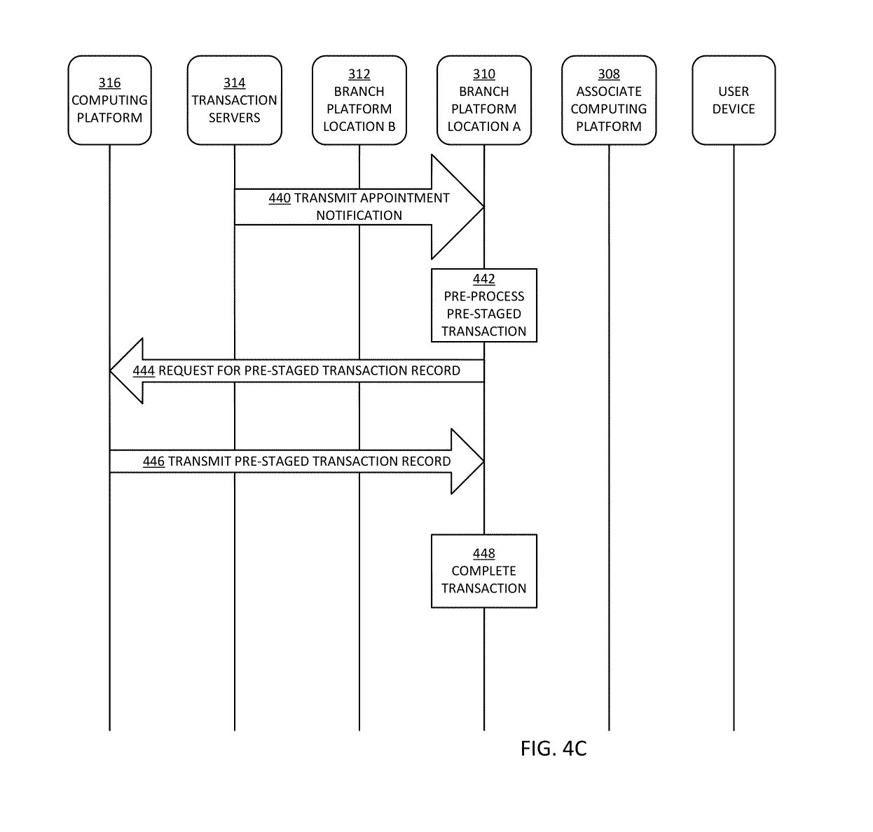

FIGS. 4A-4C depict an illustrative event sequence for completing a pre-staged transaction at a selected or scheduled time and location. In FIG. 4A, at step 400, a user or requestor may initiate a request for an account login interface from one or more transaction servers 314. For example, the user may use a user device (e.g., ATM 302, personal computing device 304, and/or mobile device 306) to request the account login interface via a browser, a webpage, and/or an application. At step 402, one or more transaction servers 314 may transmit the account login interface to the user device in response to the request. At step 404, the user may enter login information such as a username, password, and/or login code via the user device and transmit the login information from the user device to the one or more transaction servers 314. At step 406, one or more transaction servers 314 may authenticate the user based on the login information and transmit a banking interface to the user device once the user is authenticated based on the login information.

A user can perform a variety of transactions via the banking interface including, for example, pre-staging a transaction to complete at a location, checking account balances, and transferring funds to and from different accounts. At step 408, a user may select a transaction type of a transaction to pre-stage. The transaction types that may be pre-staged may include, for example, a change order, money order, savings bond redemption, cashier's check, certified check, official check, banker's check, after hours depository, and/or temporary or permanent debit or credit card requests. A change order may be an order for an order for currency in certain denominations and/or coins in certain values. An after hours depository transaction may be, for example, include a customer dropping off cash, check, and/or coins in a secure area of a branch location when the branch location is closed for a bank associate to process once the branch opens for depositing the cash, check, and/or coins into the customer's banking account.

At step 410, one or more transaction servers 314 may send a transaction information request interface or form requesting transaction information. The particular transaction information requested may depend on the selected transaction type. For example, for a saving bond redemption, the requested transaction information may include the type of bond (e.g., government savings bond, Series EE savings bond, Series I savings bond), denomination, serial number, the date of redemption, and value of the bond. As another example, for a cashier's check, the requested transaction information may include the amount of the cashier's check, account from which the funds for the cashier's check are to be deducted, and the name of the payee. For a change order transaction, the requested transaction information may include the requested amount for each denomination and/or coin. As yet another example, the requested transaction information for an after hours depository may include an amount in cash of each denomination, check information (e.g., check number, amount, payer), total coin value or total value in each type of coin, and a branch location at which the cash and/or check(s) will be dropped off.

At step 412, the user can enter the requested transaction information into the interface on the user device. At step 414, one or more transaction servers 314 can receive the transaction information from the user via the user device. At step 416, one or more transaction servers 314 can send a transaction request to computing platform 316. In response to receiving the transaction request, computing platform 316 creates a transaction record of the transaction request at step 418. At step 420, computing platform 316 stores the transaction record in a memory or database. The transaction record may appear in the requestor's account transaction history as a pending transaction.

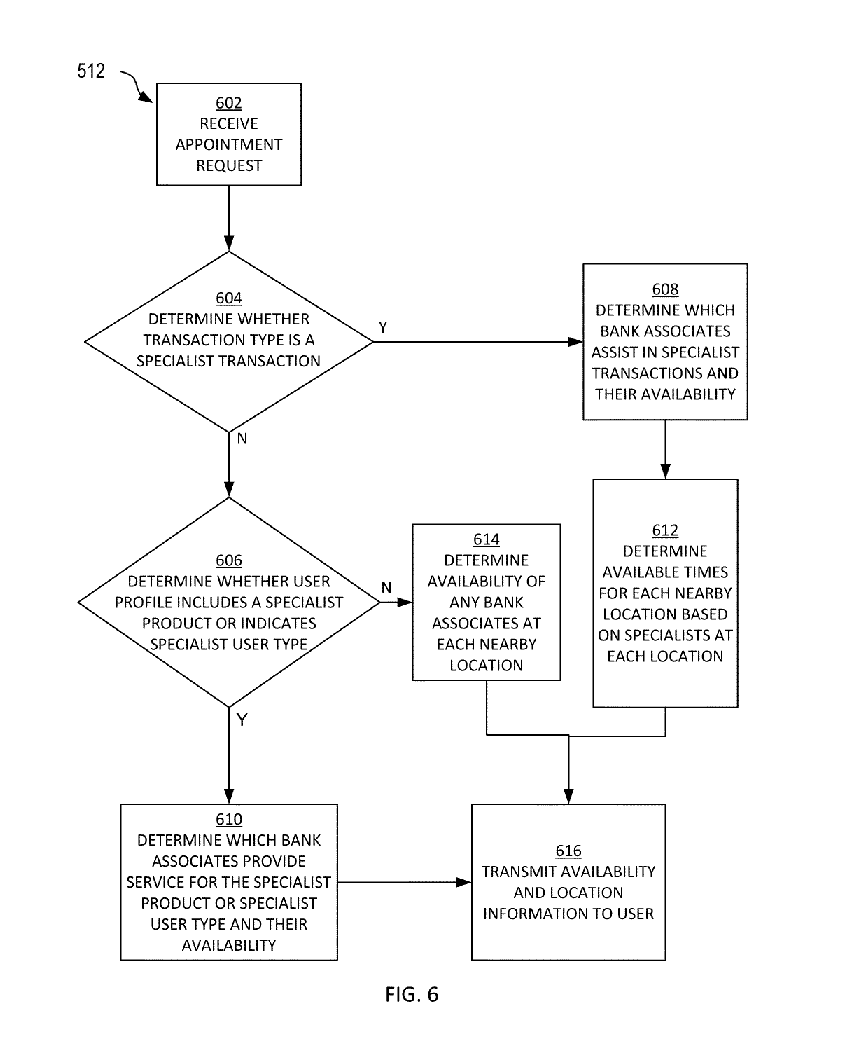

At step 422, one or more transaction servers 314 can generate and send an appointment request interface to the user device. At step 424, the user can enter or provide a preferred location to complete the transaction such as by entering a zip code, city, and/or state and/or a preferred date and/or time to complete the transaction. At step 426, one or more transaction servers 314 can determine the nearest locations at which the user can complete the pre-staged transaction based on the transaction type requested, a distance from the preferred location, a region of the preferred location, a profile of the requesting user, and/or associates of a financial institution working at a particular branch of a financial institution. For example, certain associates may be trained to handle certain types of transactions, and the appointment availability for a particular transaction type at a branch location may depend on the availability of the associate who handles the transaction type of the pre-staged transaction and/or who specializes in the needs of a certain type of user. A profile of the requesting user may be stored in a database and include information about accounts and account types that the user has and/or type of user. The determination of appointment and location availability is described in more detail with respect to FIG. 6.

At step 428, one or more transaction servers 314 can send the nearest location information to the user device. The nearest location information can include a list of locations and available times identified in step 426 from which a user can select to complete the transaction. At step 430, based on the nearest location information, the user can select via the user device a convenient location and time (and date) to complete the pre-staged transaction and send the selected appointment time and location to one or more transaction servers 314. The user may further specify a designated party to complete the location at the selected time and location and send the information about the designated party with the selected appointment time and location. For example, the user or requestor can choose to complete the transaction on March 5th at 2 pm at branch location A and list a name of a designated party such as a family member or employee to complete the transaction at the scheduled time and place. At step 438, one or more transaction servers send an appointment confirmation notification to the user. The appointment confirmation may be in the form of an e-mail, a secure message to the user's banking account, and/or a text to the user's mobile device. The appointment confirmation may include information about the transaction such as the transaction type, a transaction identifier (e.g., number, barcode), name of the person who will be at the appointment to complete the transaction, time and branch location of the appointment, and associate or specialist who will be assisting the user in completing the transaction. For some types of transactions, additional information may be included in the confirmation. For a savings bond redemption transaction, the information may include the value of the savings bond based on an entered redemption date or appointment date and indicate the time period for which the value is valid.

At step 440, one or more transaction servers 314 can transmit an appointment notification to the selected branch. For example, the user may have selected branch location A, and the one or more transaction servers 314 can transmit the appointment notification to branch platform 310 at location A. The notification may be in the form of an e-mail to an associate or manager at location A or the specialist handling the transaction at location A and may be stored in a scheduling system or database such as a calendar. At step 442, a computing device of the branch platform 310 at location A may be used to access the pre-staged transaction information to pre-process the transaction before the user's arrival at branch location A or the appointment time. For example, an associate may use branch platform 310 to request the transaction record from computing platform 316 to pre-process the transaction, by for example, searching by transaction identifier and/or the user's name. Pre-processing may include performing various steps that do not require the user's involvement or presence to reduce or minimize the amount of time the user spends at the branch location to complete the transaction. For example, for a change order transaction, the requested amounts in the specified denominations or coins may be prepared and set aside prior to the scheduled time such that when the user arrives at branch location A, the branch associate can verify the that the customer at the branch for the appointment is authorized to pick up the change order using the user's ID and/or an authorization code or barcode, locate the prepared change order, give the prepared change order to the customer, and complete the transaction in the transaction records. As another example, the transaction may be for a certified check in which case the certified check may be prepared or printed prior to the user's scheduled time. When the user arrives, the certified check may be released to the user and the funds for the certified check deducted from the user's account. The pending transaction in the requesting user's account may be changed to posted or completed once the transaction has been processed by the associate and/or the user has completed the transaction at the branch location.

Once the pre-staged transaction is scheduled, the user or the user's designated party can arrive at or before the appointed time at the selected location, for example, Location A to complete the transaction. When the person completing the transaction arrives at the selected location, the user may be directed to the associate with whom he will be working to complete the pre-staged transaction. The user may be directed by, for example, checking in at a terminal for the appointment and/or by a greeter or other associate.

At step 444, after verifying that the customer at branch is authorized to complete the pre-staged transaction, the associate at Location A may use branch platform 310 to request the pre-staged transaction record for the user from computing platform 316. At step 446, computing platform 316 may transmit the pre-staged transaction record to branch platform 310. Using the information about the pre-staged transaction record, the associate can assist the user in performing the final steps to complete the pre-staged transaction at step 448. Using a certified check example, the associate can assist the user in completing the pre-staged certified check transaction by verifying that the user is authorized to pick up the certified check and releasing the certified check to the user. The associate may mark the transaction as completed using branch platform 310, and in response computing platform 316 may deduct the funds from the user's specified account and deposit the funds to the banking institution's general ledger account. For a cash withdrawal transaction, an associate may prepare the cash, give the cash to the user, and deduct the value of the cash from the user's account. The cash may be prepared before the user's arrival and identified or associated with the user's pre-staged transaction such that the associate need only locate the pre-prepared cash. Some transactions (e.g., cash withdrawal, change order, cashier's check, money order, official check) may be completed at an ATM or ATM with Teller Assist (ATA) via real-time video.

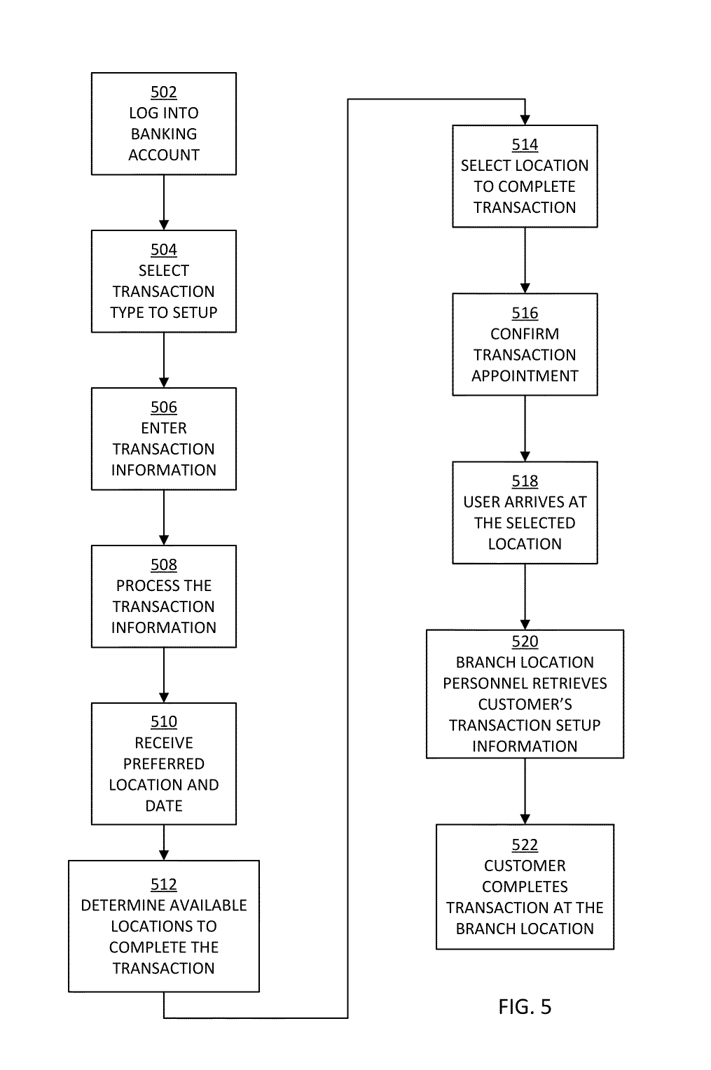

FIG. 5 shows an illustrative method of scheduling a pre-staged transaction to complete at a selected time and location according to aspects described herein. At step 502, a user can log into the user's banking account. Once logged into the banking account, the user can selected a transaction type to setup or pre-stage at step 504. At step 506, the user can enter transaction information for the selected transaction type that the user is pre-staging. The user can transmit the entered transaction information to one or more transaction servers 314.

At step 508, one or more transaction servers 314 can receive and process the transaction information. For example, one or more transaction servers 314 can instruct a computing platform 316 to create a record of the pre-staged transaction. The record may appear in the user's account as a pending transaction. In some aspects, one or more transaction servers 314 can prompt the user to enter a preferred location to complete the pre-staged transaction, for example, a zip code, city, and/or state and/or a preferred date to complete the transaction. At step 510, one or more transaction servers 314 can receive the preferred location and/or date information.

At step 512, one or more transaction servers 314 can determine available locations to complete the transaction based on the user's preferred location, the transaction type, services available at a location, and/or a profile of the user. One or more transaction servers 314 can provide nearby locations at which the user can complete the pre-staged transaction and available times at which the user can do so. The available locations can be presented as a list or in the form of a map including a name, an address and available times of each location to the user which can be filtered and sorted based on available times and/or distance from the preferred location. Step 512 will be described in more detail herein with respect to FIG. 6.

At step 514, the user can select on the interface the location for completing the transaction and an appointment time or time frame at the location for completing the transaction. The appointment time and location can be transmitted to one or more transaction servers 314. At step 516, one or more transaction servers 314 can send a notification or communication to the user confirming the transaction appointment time and location and including information about the transaction.

At step 518, the user or other designated party may arrive at the location before or after the appointment time to complete the transaction. At the location, the user may meet with the banking associate who will assist the user in completing the pre-staged transaction. At step 520, the banking associate may use banking platform 310, 312 to access or retrieve information about the user's pre-staged transaction. At step 522, the user or customer can complete the transaction. The banking associate may mark the transaction as completed in the system, and in response to the completion, computing platform 316 and/or one or more transaction servers 314 may send a notification (e.g., e-mail, secure account message, text) to the requesting user notifying the user that the transaction has been completed.

FIG. 6 shows an illustrative method for determining available locations and times (and dates) to complete the transaction according to aspects described herein. At step 602, one or more transaction servers 314 and/or computing platform 316 may receive an appointment request with a preferred location and/or date from the user device. At step 604, one or more transaction servers 314 can determine whether the pre-staged transaction is a transaction type (e.g., savings bond redemption) to be completed with assistance from a specialist. If at step 604, one or more transaction servers 314 determines that the transaction type is for a specialist, one or more transaction servers 314 can proceed to step 608. If at step 604, one or more transaction servers 314 determines that the transaction type is not a type to be completed by a specialist, one or more transaction servers 314 may proceed to step 606.

At step 608, one or more transaction servers 314 may search data in a database to identify specialists or other associates at locations within a certain distance from the preferred location or within the same region as the preferred location and/or who are available on the preferred date. The specialists may be banking associates with specialized training or skills to process or handle certain types of transactions or associates otherwise designated to handle these types of transactions. A specialist may be designated as the specialist handling a particular transaction type for a region covering the preferred location.

At step 612, one or more transaction servers 314 may determine available appointment times (and dates) for each nearby location based on specialists available at each nearby location. One or more transaction servers 314 may aggregate the availability of the specialists at each location within a certain distance from the preferred location. For example, for a savings bond redemption, a first specialist at location A may be available between 3-5 pm, and a second specialist at location A may be available between 10 am-12 pm. The availability for a savings bond redemption transaction type for location A may be between 10 am-12pm and 3-5 pm.

Returning to step 604, if in step 604 one or more transaction servers 314 determines that the transaction type is not a type to be completed with assistance from a specialist, one or more transaction servers 314 may proceed to step 606. At step 606, one or more transaction servers can determine whether a user profile of the user includes a specialist product or the user type (e.g., small business, wealth management, corporation, institution, etc.) has a specialist. A specialist product may be accounts or services provided by the banking institution, for example, a retirement account, an investment account, a home loan (e.g., mortgage, home equity loan, etc.), business loan or line of credit, cash management tool, payroll services, invoicing, and merchant services. Some banking associates may specialize in small business needs and provide services or assist in providing products for small business users. Some banking associates may specialize in wealth management and provide services or assist in providing products for users with an investment or retirement account at the banking institution or may provide investment portfolio management services. Some banking associates may provide services or products for corporate users and other institutions or mid-size businesses. If at step 606, one or more transaction servers 314 determines that the user profile of the user does not include a specialist product or the user type is not a specialist user type, one or more transaction servers 314 may proceed to step 614. At step 614, one or more transaction servers can determine availability of any banking associates at each nearby location. The banking associates may include specialists, tellers, and/or other service personnel at a location, and one or more transaction servers 314 may aggregate the availability of the general banking associates at each location.

If at step 606, one or more transaction servers 314 determines that the profile of a user matches a certain type of user or contains a specialist product, one or more transaction servers 314 may proceed to step 610. At step 610, one or more transaction servers 314 may determine which banking associates provide services for the specialist product and/or the user type and determine the availability of these banking associates. A user may be matched with a specialist based on the specialist product or the type of user. For example, a small business user may be matched with a small business specialist to complete the transaction, and the small business specialist can assist the user with any other needs while the user is at the branch location completing a transaction. Because the small business specialist knows the small business user with whom he will be meeting, the small business specialist may research the small business user's potential needs before the appointment to determine if there are any products or services that may meet the needs of the small business user. The research done can depend on the transaction type. For example, the transaction type may be cash withdrawal, and the small business specialist may research the user's withdrawal history and determine that the user normally uses online transfers to pay the user's employees. The small business specialist may identify this opportunity and educate the user during the cash pickup appointment on a product to assist with payroll which can save the user time, money, and energy over time. As another example, a user with a home loan may be matched with a loan specialist. The loan specialist may have a conversation with the user about any other needs and educate the user about options to, for example, refinance the loan and/or other loan products.

At step 616, one or more transaction servers 314 may transmit availability determined in steps 610, 612, or 614 to the user device, for example, via one or more transaction servers 314. The availability information may be presented to the user as discussed with respect to step 512 in FIG. 5.

While the aspects described herein were described with respect to a user scheduling a transaction to be completed at selected time and location, the user may schedule more than one transaction to be completed at the selected time and location. For example, a user may pre-stage a cashier's check transaction and a change order transaction for the same appointment. The system described herein may have one or more associates or specialists at the same location assist in completing the transactions according to the aspects described herein.

Aspects described herein enable a user to minimize or reduce the amount of time spent at a branch location to perform or complete a transaction. The user also benefits by confirming that a particular location provides the services that the user is interested in before arriving at the location. Meanwhile, the branch location benefits in being able to foresee what services will be needed and when the services will be needed and know the type of user who will be arriving at a particular location.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may comprise one or more non-transitory computer-readable media.

As described herein, the various methods and acts may be operative across one or more computing servers and one or more networks. The functionality may be distributed in any manner, or may be located in a single computing device (e.g., a server, a client computer, and the like).

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A method, comprising:
at a computing system comprising at least one processor, a memory, and a communication interface:
receiving, via the communication interface and from a user device, login information for an account of a user.
receiving, via the communication interface and from the user device, a selection of a transaction type of a transaction to setup;
receiving, via the communication interface and from the user device, transaction information for the transaction;
storing, by the at least one processor, the transaction information in a transaction record;
determining, by the at least one processor, available locations and times at the available locations to complete the transaction based on at least one of the transaction type, services available at a location, a user profile of the user, and a preferred location;
transmitting, via the communication interface and to the user device, the available locations and times;
receiving, via the communication interface and from the user device, an appointment request for an appointment comprising a selected time and location based on the transmitted available locations and times; and
scheduling, by the at least one processor, the transaction for completion at the selected time and location.

2. The method of claim 1, wherein determining the available locations and times at the available locations to complete the transaction comprises:
determining whether a transaction type corresponds to a specialist transaction type; and
in response to determining that the transaction type corresponds to the specialist transaction type, determining which associates assist in the specialist transaction type and their availability.

3. The method of claim 1, wherein determining the available locations and times at the available locations to complete the transaction comprises:
determining whether the user profile of the user includes a specialist product; and
in response to determining that the user profile of the user includes a specialist product, determining which associates provide service for the specialist product and their availability.

4. The method of claim 1, wherein determining the available locations and times at the available locations to complete the transaction comprises:
determining whether a user profile of the user includes a specialist product; and
in response to determining that the user profile of the user does not include a specialist product, determining availability of any associates at within a predetermined distance to the preferred location.

5. The method of claim 1, further comprising:
receiving a request for the transaction information to pre-process the transaction before the selected time; and
responsive to the request, transmitting the transaction information to a computing platform at the selected location.

6. The method of claim 1, wherein scheduling the transaction for completion at the selected time and location comprises:
transmitting, to a computing platform at the selected location, a notification of the appointment comprising the transaction information and a designated party to complete the transaction.

7. The method of claim 1, further comprising:
after the selected time, receiving, from a computing platform at the selected location, a request for the transaction information to complete the transaction.

8. The method of claim 1, further comprising:
receiving an indication that the transaction is completed; and
responsive to the indication, deducting funds from an account of the user.

9. The method of claim 1, wherein the transaction type comprises at least one of a change order, a money order, a savings bond redemption, a cashier's check, a certified check, an official check, an after hours depository, and a temporary or permanent debit or credit card request.

10. The method of claim 1, wherein determining available locations and times at the available locations to complete the transaction comprises:
determining whether the user profile of the user indicates a first type of user; and
in response to determining that the user profile of the user indicates the first type of user, identifying a specialist who specializes in assisting the first type of user.

11. The method of claim 10, wherein the first type of user is a small business user and the specialist is a small business specialist.

12. An apparatus, comprising:
at least one processor; and
a memory storing instructions that when executed by the at least one processor cause the apparatus to:
receive, from a user device, login information for an account of a user.
receive, from the user device, a selection of a transaction type of a transaction to setup;
receive, from the user device, transaction information for the transaction;
store, by the at least one processor, the transaction information in a transaction record;
determine, by the at least one processor, available locations and times at the available locations to complete the transaction based on at least one of the transaction type, services available at a location, a user profile of the user, and a preferred location;
transmit, to the user device, the available locations and times;
receive, from the user device, an appointment request for an appointment comprising a selected time and location based on the transmitted available locations and times; and
schedule, by the at least one processor, the transaction for completion at the selected time and location.

13. The apparatus of claim 12, wherein determining the available locations and times at the available locations to complete the transaction comprises:
determining whether a transaction type corresponds to a specialist transaction type; and
in response to determining that the transaction type corresponds to the specialist transaction type, determining which associates assist in the specialist transaction type and their availability.

14. The apparatus of claim 12, wherein determining the available locations and times at the available locations to complete the transaction comprises:
determining whether the user profile of the user includes a specialist product; and
in response to determining that the user profile of the user includes a specialist product, determining which associates provide service for the specialist product and their availability.

15. The apparatus of claim 12, wherein determining the available locations and times at the available locations to complete the transaction comprises:
determining whether a user profile of the user includes a specialist product; and
in response to determining that the user profile of the user does not include a specialist product, determining availability of any associates at each location within a predetermined distance from the preferred location.

16. The apparatus of claim 12, wherein the memory storing instructions that when executed by the at least one processor cause the apparatus to:
receive a request for transaction information to pre-process the transaction; and
responsive to the request, transmit the transaction information to a computing platform at the selected location.

17. The apparatus of claim 12, wherein scheduling the transaction for completion at the selected time and location comprises:
transmitting, to a computing platform at the selected location, a notification of the appointment comprising the transaction information and a designated party to complete the transaction.

18. The apparatus of claim 12, wherein the memory storing instructions that when executed by the at least one processor cause the apparatus to:
after the selected time, receiving, from a computing platform at the selected location, a request for the transaction information to complete the transaction
receiving an indication that the transaction is completed; and
responsive to the indication, deducting funds from an account of the user.

19. The apparatus of claim 12, wherein determining available locations and times at the available locations to complete the transaction comprises:
determining whether the user profile of the user indicates a first type of user; and
in response to determining that the user profile of the user indicates the first type of user, identifying a specialist who specializes in assisting the first type of user.

20. One or more non-transitory computer-readable media having instructions stored thereon, that when executed by one or more computers, cause the one or more computers to:
receive, from a user device, login information for an account of a user.
receive, from the user device, a selection of a transaction type of a transaction to setup;
receive, from the user device, transaction information for the transaction;
store the transaction information in a transaction record;
determine available locations and times at the available locations to complete the transaction based on at least one of the transaction type, services available at a location, a profile of the user, and a preferred location;
transmit, to the user device, the available locations and times;
receive, from the user device, an appointment request for an appointment comprising a selected time and location based on the transmitted available locations and times; and
schedule the transaction for completion at the selected time and location.
